(19) United States
(12) Patent Application Publication
(10) Pub. No.: US 2002/0015038 A1
(43) Pub. Date: Feb. 7, 2002

(54) System and method for evaluating pockets in protein

(76) Inventors: Nehal Manhar Patel, Boston, MA (US); Ciamac C. Moallemi, Boston, MA (US); Edward A. Wintner, Cambridge, MA (US); Keith Mason, Malden, MA (US)

Correspondence Address: HALE AND DORR, LLP, 60 STATE STREET, BOSTON, MA, 02109

(21) Appl. No.: 09/882,606

(22) Filed: Jun. 15, 2001

Related U.S. Application Data
(60) Provisional application No. 60/212,332, filed on Jun. 16, 2000.

(51) Int. Cl. G06T 17/00

(52) U.S. Cl. 345/419; 345/424

(57) ABSTRACT

A system and method are used to evaluate concavities in a complex surface, such as for determining protein pockets in a protein model.

### CROSS-REFERENCE TO RELATED APPLICATION

This application claims priority from provisional application Ser. No. 60/212,332, filed Jun. 16, 2000, which is incorporated herein by reference.

### BACKGROUND OF THE INVENTION

The present invention relates to the evaluation of a surface, particularly a surface with many concave and convex regions, and in preferred embodiments, relates to the evaluation of biopolymers and particularly protein molecules.

The science of protein x-ray crystalography is well established. X-ray crystal structures of over 10,000 natural and non-natural proteins have been determined and deposited in the Cambridge University Protein Data Bank (PDB). An x-ray structure of a protein provides spatial coordinates of all or most of the atoms in a protein, thus allowing a molecular model of the protein to be constructed (FIG. 1A). Such a model is often constructed on a computer, thus allowing the atoms to be displayed for viewing in a three-dimensional (3D) computer modeling program such as TRIPOS or RASMOL. With the coordinates of the protein's atoms, it is a straightforward task to determine a 3D atomic surface of the protein (FIG. 1B) which would be accessible to potential ligand molecules (i.e., molecules that would bind to the protein with some measurable affinity).

This 3D atomic surface can be created by modeling the van der Waals radii of all of the protein's atoms and then rolling a “probe ball” of radius R over the van der Waals model thus formed. Exemplary methods of creating such protein surfaces are software products known as MSMS and MSROLL. The 3D atomic surface of the protein which would be accessible to potential ligand molecules is thus defined as the set of points at which the probe ball is tangent to the van der Waals model of the protein atoms. The radius R is generally on the order of an atomic radius; e.g., a “probe ball” of 1.8 Angstroms may be used to successfully determine a 3D protein surface.

Once a 3D atomic surface of the protein is created which would be accessible to potential ligand molecules, there remains a common problem of defining which areas of a protein surface are most likely sites for ligands to bind. Such areas are referred to as “protein pockets” and are essentially empty concavities on a protein surface. Determining the location of such protein pockets is needed for subsequent rational drug design: in order to computationally design molecular ligands to a protein, a particular pocket of the protein for which the ligand will be designed should be known. Rational drug design is founded on the principles of molecular recognition, which are based on the shape and functional complementarity of ligand and protein. Once the particular shape and functionality of a given protein pocket is determined, rational drug design of complementary ligands or of combinatorial libraries of ligands can begin based on this information. Thus, it is of significant importance to select areas of a protein surface that are likely sites for ligands to bind.

The likelihood of designing a successful ligand for a protein depends greatly on the 3D shape of the protein pocket for which the ligand is being designed. Because of the “hydrophobic effect” in molecular recognition, which states that energy of binding is gained by displacing water molecules from the non-polar surface of both ligand and protein (Ajay and Murcko, Journal of Medicinal Chemistry, 1995, p. 4953), it is well established that one of the most determinant factors in protein/ligand binding is the percent area of non-polar ligand surface that is in contact with a protein. Thus, molecular functionality factors being equal, the more completely a ligand is enveloped by a protein surface, the better its chance of binding successfully to the protein. It follows that in order to design ligands to a given protein, it is important to find areas of the protein (pockets) which display a highly concave nature and are thus able to envelop potential ligands to a great extent.

The concavity of a surface may be measured in many ways, and several methods currently exist which define concave areas of protein surfaces for subsequent rational drug design. These include the methods of the CAnGAROO Project at the University of Leeds, which are based on the measurement of “average curvature at a point” to identify concavities. Other methods are based on identifying concavities with “probe spheres”, a method of mathematically providing spheres into a volume in the protein model. Still other methods, such as CAST, are based on identifying “alpha surfaces” of proteins.

### SUMMARY OF THE INVENTION

The present invention includes systems and methods for evaluating convex and concave surfaces on a model, particularly a model of an irregular surface with a number of concave and convex regions on the surface. A series of slicing planes are provided parallel to each other through the model, and preferably multiple series of slices at different angles are provided through the model. Using a slicing place, the surface of the model, and other minimum and/or maximum parameters, the concavity of the model is determined and a desired region or formation is found.

A concave region of volume may be bounded solely by a slicing plane, or it can also be bounded by one or more planes perpendicular to the slicing plane, or by another slicing plane parallel to and spaced from the first slicing plane.

The method also includes aggregating discovered pockets based on their occupying intersection volumes of space, and partitioning the aggregated pockets into smaller overlapping volumes.

The method further includes ranking the concave areas on the model surface by geometric properties, volume encompassed by the slice and the model, opening area where the slice intersects the model, and area bounded by a plane parallel or perpendicular to the slicing plane.

The system and method of the present invention are usable with irregular surfaces with many convex and concave variations, and is particularly useful with biomolecules, more preferably biopolymers, and still more preferably with proteins. The method can also be used with RNA and DNA.

In the case of protein, knowledge about these concave areas, referred to as protein pockets, can be used to determine where a ligand will likely bind, and to design a ligand suitable for that pocket. Thus, the system and method of the present invention can be used as part of a rational drug design process. Other features and advantages will become apparent from the following detailed description, drawings, and claims.

### BRIEF DESCRIPTION OF THE DRAWINGS

FIG. 1A is an example of a molecular model of a protein.

FIG. 1B is a three dimensional representation of the atomic surface of the protein shown in FIG. 1A.

FIG. 2A is a perspective view of a pocket in a protein model bounded by a slice.

FIG. 2B is a perspective view of a pocket as determined by previous methods and having a thre3e dimensional boundary.

FIGS. 3A, 4A, and 5A are three dimensional drawings of protein models with planar slices taken to define potential protein pockets.

FIGS. 3B, 4B, and 5B are perspective views showing the pockets created by the planar slices in FIGS. 3A, 4A, and 5A, respectively, and referred to a simple pocket, a partial pocket, and a tunnel pocket, respectively.

FIGS. 6-9 are 3D models showing a pocket of highest volume determined according to the present invention, and an actual ligand pocket determined by X-ray structure, thereby demonstrating that the method of the present invention can be effective for determining potential ligand pockets. The proteins in FIGS. 6-9 are HIV-1 Protease, Heat Shock Protein 90, Stromelysin, and Dihydrofolate Reductase, respectively.

FIG. 10 is a depiction of a protein surface sliced by a plane.

FIGS. 11 and 12 illustrate steps in the slicing process when a slice passes through a modeling triangle.

FIG. 13 is a 3D model of a protein with a slice, and a projection of the outline of the two components created by the slice.

FIG. 14 shows an example of components resulting from a slice.

FIG. 15 shows a protein with a slice and the computation of a cross-section and outer boundary.

FIG. 16 shows examples of finding outer boundaries of cross sections with a slice through a protein.

FIG. 17 illustrates partial openings from outer boundaries in the example of FIG. 16.

FIG. 18 shows the determination of special edges.

FIG. 19 demonstrates a number of planar slices through a model.

### DETAILED DESCRIPTION

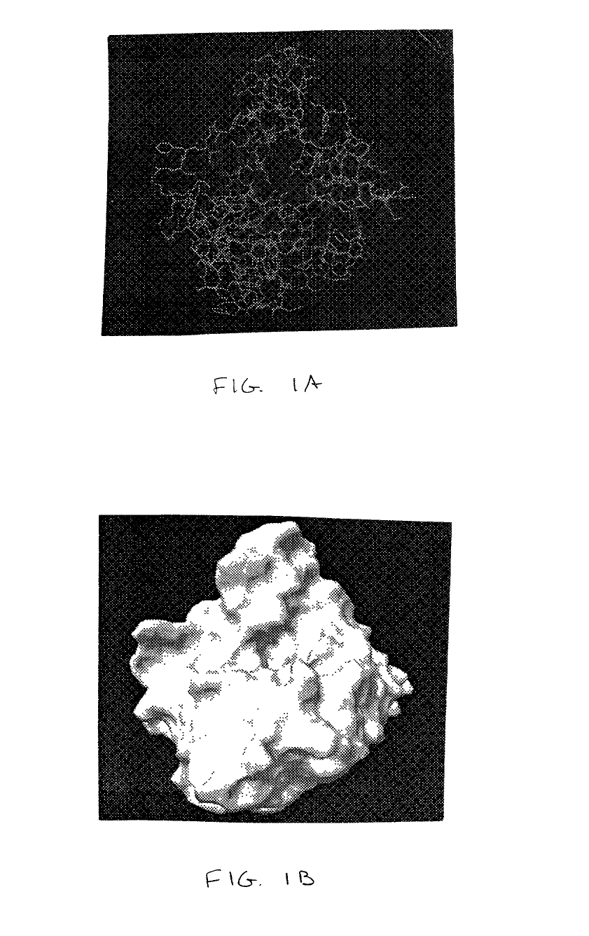

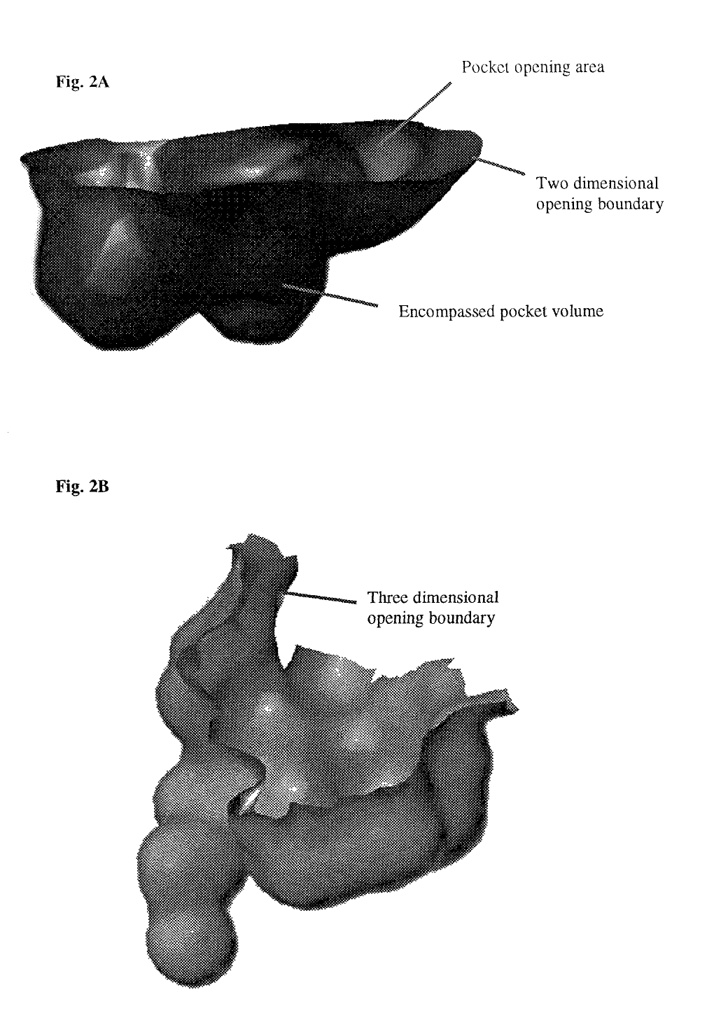

The present invention, while having more general applicability, is described here in connection with finding protein pockets using protein models. A three-dimensional (3D) molecular model of a protein is shown in FIG. 1A, and a 3D surface representative of the atomic surface of the protein is shown in FIG. 1B. Databases and programs are known for providing molecular models of a protein and also for creating 3D surface model from a molecular model.

The system and method of the present invention can be used to identify concave regions on the surface of proteins and other three dimensional surfaces that can be modeled, including highly irregular surfaces with a large number of convex and concave variations.

In the processes described below, a surface is a 2D object embedded in 3D space composed of a set of triangles satisfying basic consistency properties which are commonly understood in the field of computational geometry. A surface may contain multiple components (i.e., disjoint regions). The vertices of a surface are the set of vertex points of the triangles that compose the surface.

As determined by the method of the present invention, a protein pocket is a region in a three dimensional (3D) space bounded by triangles used to create the model from a protein surface and one or more bounding planes, such that any point in the interior of the pocket is not contained in the interior region of the protein surface. A potential protein pocket is a region in 3D space bounded by triangles from a protein surface and one or more bounding planes, but with no conditions placed on the points in the interior region of the pocket. A model of the protein is sliced by a series of parallel planar slices so that each slice creates a potential protein pocket bounded by the slicing plane. This process can be repeated by making a number of parallel slices through the model at multiple angles.

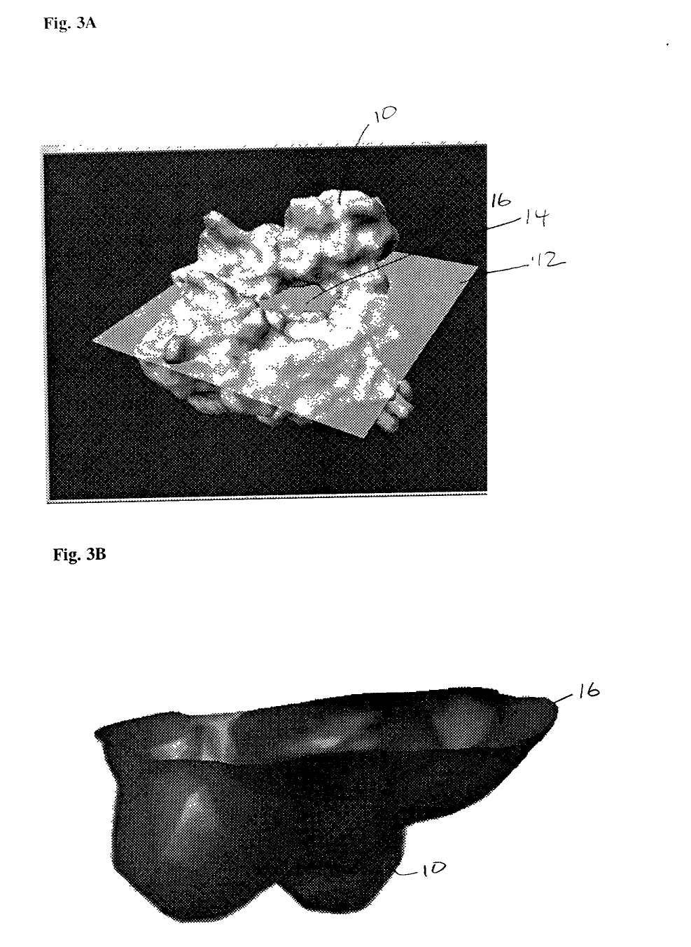

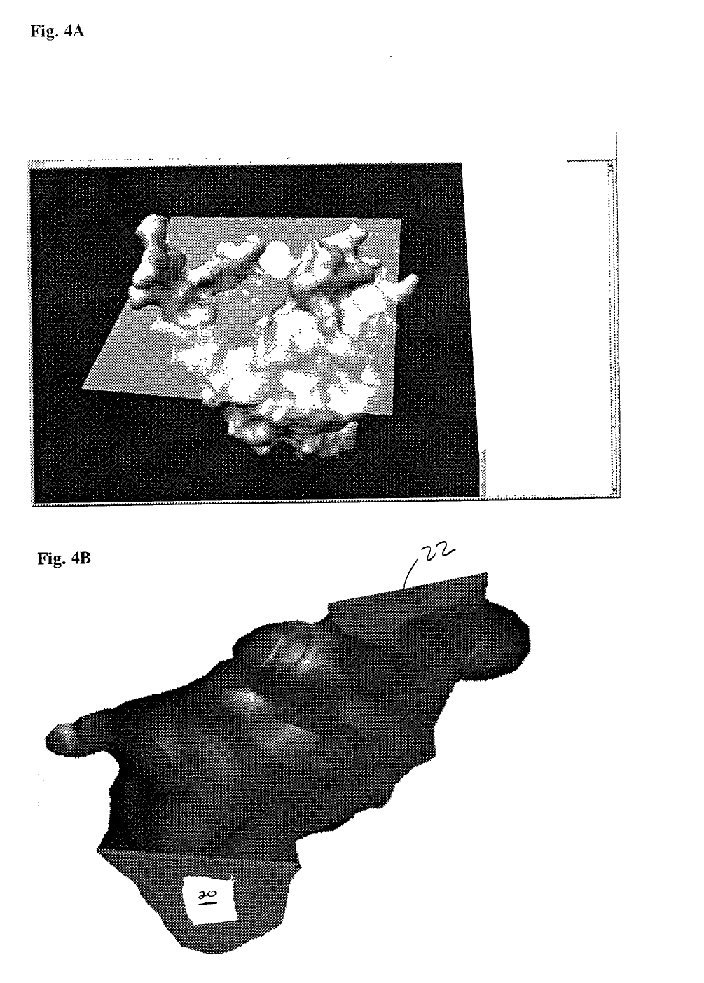

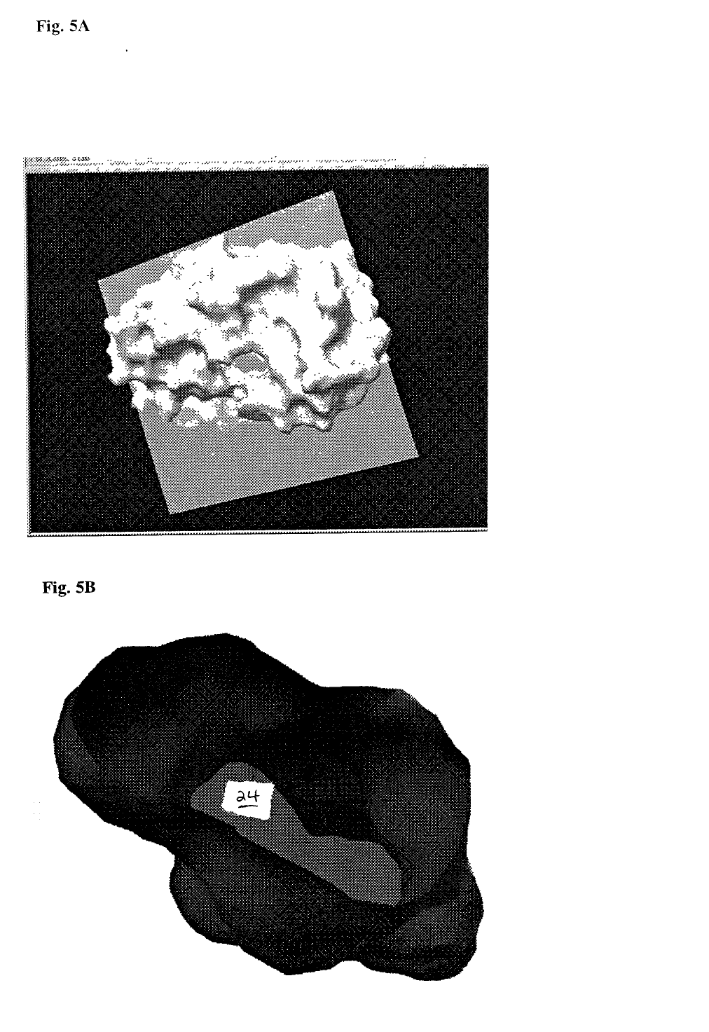

Examples of models of proteins are shown with planar slices in FIGS. 3A, 4A, and 5A. In FIG. 3A, three dimensional model of a surface 10 of a protein is sliced with a plane 12 to produce an area 14 bounded by portions of surface 10 but outside surface 10. Area 14 has a perimeter 16 where plane 12 intersects surface 10. A planar slice may determine and define a protein pocket as shown in FIG. 3B. Alternatively, added “opening completion parameters” may be used, such as one or more planes 20, 22 perpendicular to the slicing place as shown in FIG. 4B, or with added “tunnel bottom completion parameters,” i.e., another plane 24 parallel to the slicing plane as shown in FIG. 5B.

A simple pocket is a protein pocket with only one bounding plane, i.e., the slicing plane, as shown in FIG. 3B. The planar slice intersects the surface to create a closed perimeter in the slice. In a simple pocket, if one looks down into the pocket, the cross-section gets progressively smaller until the bottom of the pocket is reached.

A partial pocket is a protein pocket bounded by the slicing plane and one or more planes that are perpendicular to the slicing plane, as shown in FIG. 4B. This type of pocket is similar to a simple pocket, but the surface intersecting the slice does not create a closed perimeter, but has open portions. These open portions are “filled in” by one or more perpendicular planes 20, 22.

A tunnel pocket is a protein pocket that has a total of two bounding planes, one of which is the slicing plane, and the other of which is a slice 24 parallel to the slicing plane as shown in FIG. 5B. A tunnel pocket is used, for example, when a protein model has a surrounded “hole” extending through a portion of the protein (like a donut).

Referring to FIGS. 2A and 2B, the pocket opening of a potential protein pocket is the region of the slicing plane bounded by the protein surface and any additional bounding planes (FIG. 2A). Two significant criteria in evaluating the concavity of different protein surface areas to be compared are “encompassed pocket volume” and “pocket opening area” (FIG. 2A). The present invention allows such calculation to be rapidly performed. In some other methods described in the background section above, such as CAnGAROO, the output protein pockets would be found with three dimensional opening boundaries as shown in FIG. 2B, thus making the calculation of pocket volume and pocket opening area difficult and imprecise.

Because the resulting pockets determined according to the present invention are all defined by a plane at the pocket openings (i.e., there is a two dimensional opening boundary), pocket volume and pocket opening area can be calculated precisely using known computational geometry methods, allowing rapid and precise evaluation of all pockets to meet user defined criteria. Thus, likelihood of ligand binding potential for a given area of a protein surface can be rapidly and precisely evaluated in preparation for subsequent rational design of ligands which can bind to that protein.

Identified pockets for a protein may occupy overlapping regions of space. In these instances, it is desirable to merge the overlapping pockets and compute the merged pocket volumes. The present invention accomplishes this by filling the volume of each pocket with spheres and taking unions across sets of pockets. Further, in order to identify precise regions within a merged pocket volume that are suitable for small molecule ligands, the present invention provides a method to split a merged pocket volume into multiple partitioned pocket volumes.

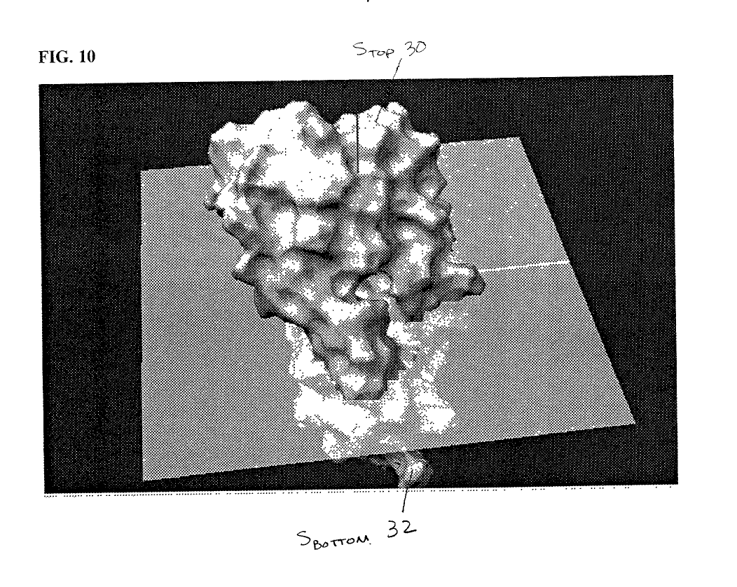

With reference also to FIGS. 10-17, the method for identifying pockets includes the following processes:

SLICE

SLICE (S, P), identifies the resultant surfaces formed by dividing the surface S into two surfaces as shown in FIG. 10: S_{TOP} 30, the portion of surface S above plane P and S_{BOTTOM} 32, the portion of surface S below plane P. This process thus provides a mechanism for redefining a sliced triangle into multiple triangles, one or more of which may be over the slicing plane, and one or more of which may be below the slicing plane.

Steps of SLICE Process:

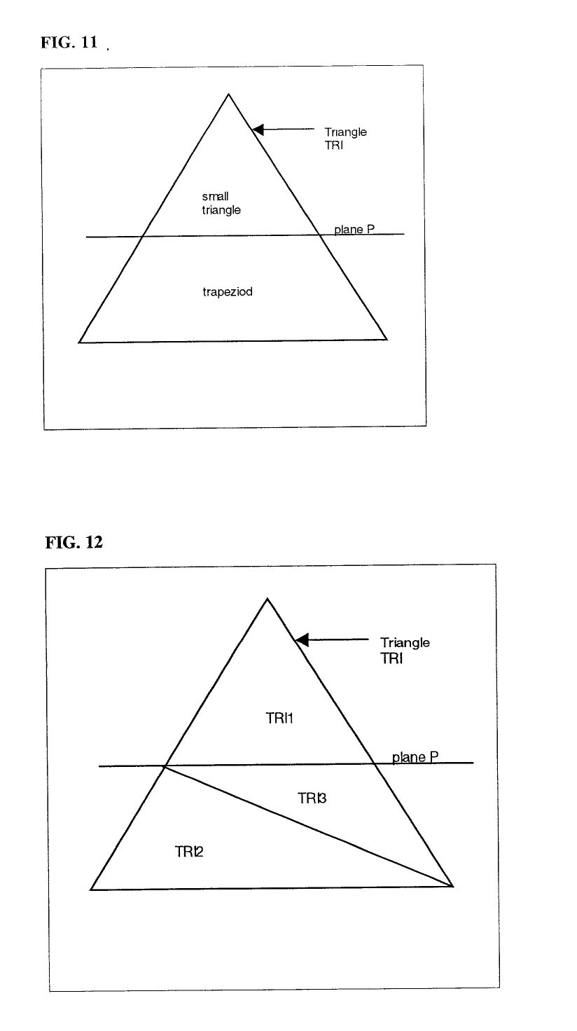

a) Let T be the set of triangles in S that are intersected by P. Each triangle TRI of T is divided by P into a smaller triangle and a trapezoid. (See FIG. 11)

b) For each triangle TRI of T, divide triangle TRI in to three new triangles: TRI1, TRI2, TRI3. Store these new triangles in the set NEW_TRI. (See FIG. 12)

c) Let NO_INTERSECT be the set of triangles in S that do not intersect P. Let ALL_TRI be the set formed by the union of NEW_TRI and NO_INTERSECT. Then, S_{TOP} is the surface formed by the triangles in ALL_TRI that have at least one vertex above P, and S_{BOTTOM} is the surface that is formed by the triangles in ALL_TRI which have at least one vertex below P.

POCKET

POCKET (S, P, FILTER) allows the determination of all protein pockets, including different types, with a slicing plane P lying on the protein surface S subject to the constraints specified by a filter structure FILTER. FILTER contains the following elements which set user-configurable parameters for determining pockets that are desirable:

FILTER.MIN_AREA

FILTER.MAX_AREA

FILTER.MIN_VOLUME

FILTER.MAX_VOLUME

FILTER.TUNNEL_STEP

FILTER.TUNNEL_FACTOR

FILTER.MAX_TUNNEL_BOTTOM

FILTER.MAX_PARTIAL_LENGTH

FILTER.MAX_PARTIAL_AREA

FILTER.TOTAL_PARTIAL_LENGTH

FILTER.TOTAL_PARTIAL_AREA

Steps of POCKET:

a) Use SLICE (S, P) to identify S_{TOP} and S_{BOTTOM}.

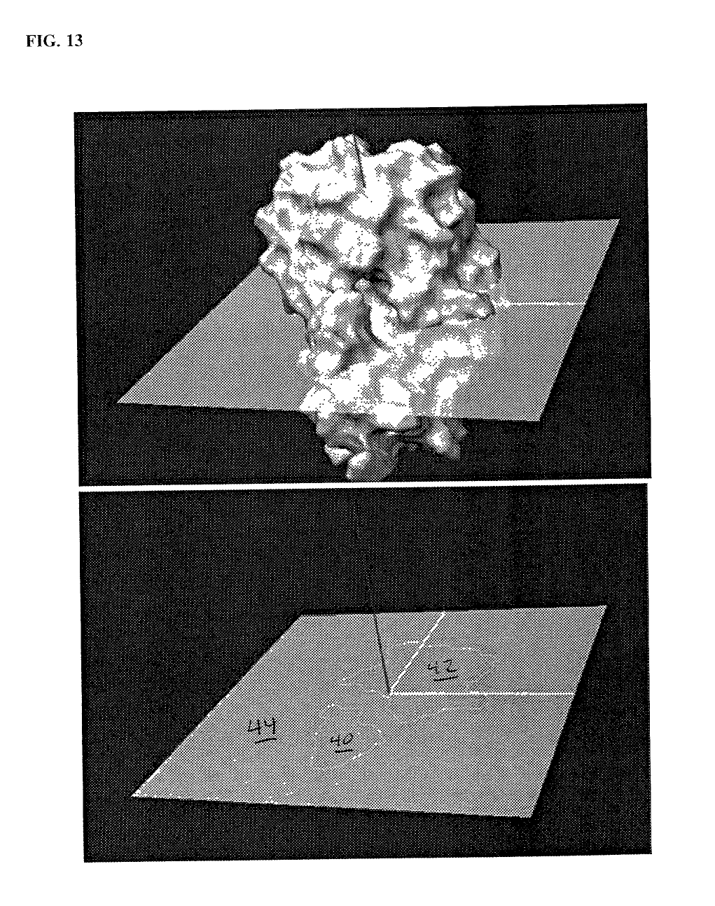

b) Let V be the set of vertices of S_{BOTTOM} that lie on P. Calculate the set CROSS_SECT of plane-connected components for the vertices in V. Two vertices in V are in the same plane-connected component, C_{J}, if there is a path of triangle edges that join them that lies entirely on P. FIG. 13 shows two separate plane connected components 40, 42 in plane 44.

c) Use SIMPLE_POCKET (CROSS_SECT, S_{BOTTOM}, P, FILTER) (described below) to identify the simple pockets that have plane P as a slicing plane. Store the computed pockets in the set POCK.

d) Use TUNNEL_POCKET (CROSS_SECT, S_{BOTTOM}, P, FILTER) (described below) to identify the tunnel pockets that have plane P as a slicing plane. Add the resulting pockets to POCK.

e) Use PARTIAL_POCKET (CROSS_SECT, S_{BOTTOM}, P, FILTER) (described below) to identify the partial pockets that have plane P as a slicing plane. Add the resulting pockets to POCK.

f) Repeat steps (c)-(e), replacing S_{BOTTOM} with S^{TOP}.

g) Return the set of all protein pockets, POCK.

SIMPLE_POCKET

SIMPLE_POCKET (CROSS_SECT, S, P, FILTER) computes the simple pockets on the surface S that have pocket openings contained in the set of components CROSS_SECT and satisfy the constraints specified by the filter structure FILTER.

Definitions:

Two vertices V_{J} and V_{K} in surface S are surface-connected with respect to surface S if there exists a path of triangle edges in S that join V_{J} and V_{K}.

Two components C_{J} and C_{K} in CROSS_SECT are surface-connected with respect to surface S if any vertex in C_{J} is surface connected to any vertex in C_{K}.

A component C_{J} in CROSS_SECT and triangle TRI in the surface S are surface-connected with respect to surface S if any vertex in C_{J} is connected to any vertex of TRI.

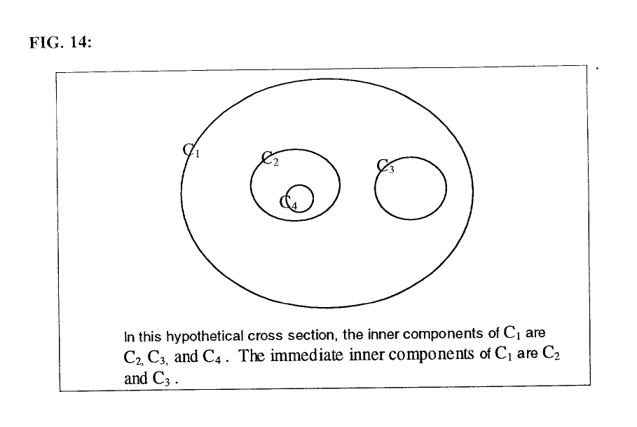

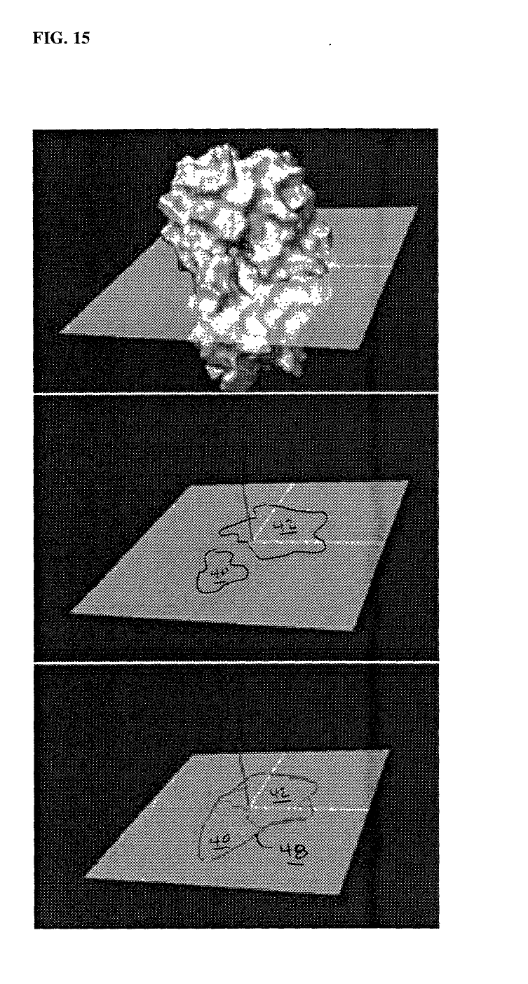

A component C_{K} in CROSS_SECT is an inner component of a component C_{J} if C_{K} lies entirely within the region bounded by C_{J} (See FIG. 14).

A component C_{K} in CROSS_SECT is an immediate inner component of a component C_{J} if C_{K} is an inner component of C_{J} and there exists no component C_{N} of CROSS_SECT such that C_{N} is an inner component of C_{J} and C_{K} is and inner component of CN (See FIG. 14).

Steps for SIMPLE_POCKET:

a) For each component C_{J} of CROSS_SECT, if C_{J} is surface-connected with respect to surface S to all of its immediate inner components and no other components of CROSS_SECT:

i) Form a potential pocket PP which consists of all the triangles in surface S surface-connected to C_{J}.

ii) Pick any interior point POINT in potential pocket PP.

iii) If POINT is not contained in the interior region of surface S, and the area of component C_{J} is less than FILTER.MAX_AREA and greater than FILTER.MIN_AREA and the volume of PP is less than FILTER.MAX_VOLUME and greater than FILTER.MIN_VOLUME, then PP is a valid simple pocket.

b) Return the set POCK of valid simple pockets determined from examining each component in CROSS_SECT using step (a).

TUNNEL_POCKET

TUNNEL_POCKET (CROSS_SECT, S, P, FILTER) identifies the tunnel pockets on the surface S that have pocket openings contained in the set of components CROSS_SECT and satisfy the constraints contained in filter structure FILTER.

Steps for TUNNEL_POCKET:

a) For each component C_{J} of CROSS_SECT, if C_{J} contains no inner components and is surface-connected with respect to S to at least one other element of CROSS_SECT,

1. Let DIST=FILTER.TUNNEL_STEP

2. Let P′ be the plane parallel to plane P located a distance DIST below plane P

3. If the intersection of P′ and surface S is empty, go to step 6; else identify the portions S_{TOP′} and S_{BOTTOM′} of surface S that lie above and below P′ using SLICE (S, P′). For the sake of notation, let S′=S_{TOP′}.

4. Let CROSS_SECT′ be the set of plane-connected components of the vertices of S′ that lie on P′.

5. If C_{J} in CROSS_SECT is surface-connected with respect to S′ to one and only one element C_{J}′ in CROSS_SECT′ and the area of C_{J}′ is less than (Area of C_{J})* FILTER.TUNNEL_FACTOR:

Store C_{J}′ in the set VALID_BOTTOMS, let DIST=DIST+FILTER.TUNNEL_STEP, and go to step 2. Else: Go to step 6.

6. If the set VALID_BOTTOMS is non empty, find the element C_{J}′ in VALID_BOTTOMS which satisfies the following condition: C_{J}′ has an area less than FILTER.MAX_TUNNEL_BOTTOM and for all elements in VALID_BOTTOMS whose area is less than FILTER MAX_TUNNEL_BOTTOM, and the plane in which C_{J}′ lies is the furthest distance from P.

7. If such a C_{J}′ exists, triangulate (i.e. decompose a 2D polygon into triangles) C_{J}′.

8. Let P′ be the plane in which C_{J}′ lies. Add the triangles calculated in step 7 to the surface S_{TOP′} calculated using SLICE(S, P′); denote this surface as S″. Let POCK equal the set of triangles in S″ surface-connected (with respect to S″) to C_{J}.

9. If the area of C_{J} is less than FILTER.MAX_AREA and greater than FILTER.MIN_AREA and the volume of POCK is less than FILTER.MAX_VOLUME and greater than FILTER.MIN_VOLUME, then POCK is a valid tunnel pocket.

b) Return to step (a) for each remaining component in CROSS_SECT.

PARTIAL_POCKET

PARTIAL_POCKET (CROSS_SECT, S, P, FILTER) identifies the partial pockets on the surface S that have pocket openings contained in the set of components CROSS_SECT and satisfy the constraints contained in filter structure FILTER.

Steps for PARTIAL_POCKET:

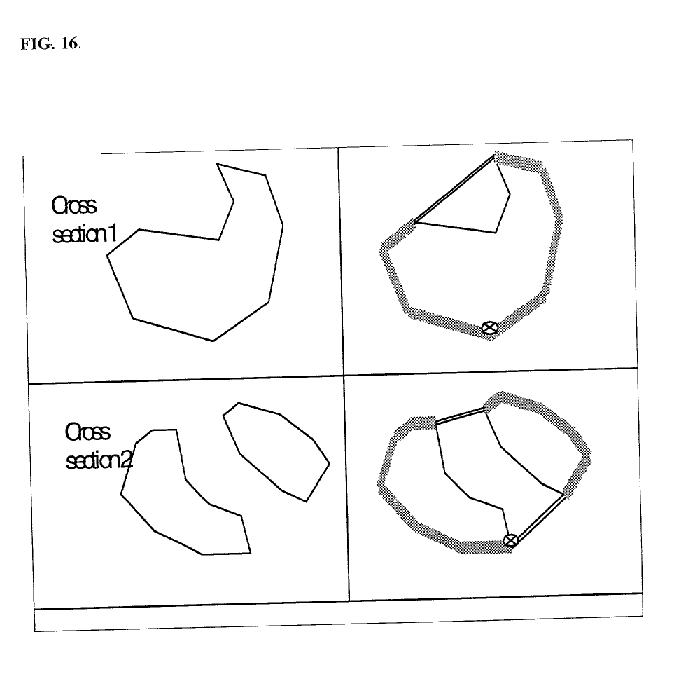

1) For a set of the components CROSS_SECT, identify an outer boundary. In FIGS. 15 and 16, components 40 and 42 have boundaries as shown, and outer boundary 48 is created to encompass both components 40, 42. FIG. 16 shows two examples of finding the outer boundary of cross sections. The circle with an X indicates the lowest vertex of the cross section. The traversal described in step 1(c) starts at this point and continues counter clockwise along the existing cross section edges and newly added special edges (the double lines) until the starting point is encountered again.

An outer boundary is the set of edges in CROSS_SECT plus additional edges (special edges) between certain vertices of CROSS_SECT that are to be determined in the following way:

a) Assign a label called STATE to all of the vertices in CROSS_SECT. Set the initial value of STATE for all vertices to be un-handled.

b) Find the lower most point (i.e. the point with the smallest y-coordinate) PNT in CROSS_SECT which has STATE=un-handled.

c) Until the point PNT is reached again, traverse the edges in CROSS_SECT in the following manner:

1. Find the PNT′ such that PNT′ is within a distance FILTER.MAX_PARTIAL_LENGTH of PNT and such that segment connecting PNT and PNT′ makes the smallest counter clockwise angle with the previous edge in the traversal. For the first point in the traversal, designate the direction of the previous edge to be in the positive x direction.

2. If PNT′ is not an immediate neighbor of PNT, add a special edge SE between PNT and PNT′ to the set SPECIAL_EDGES. Let PNT=PNT′. Go to c).

d) For the various components of CROSS_SECT encountered in this traversal process, change all of their vertices' STATE to handled.

e) If there are any vertices in CROSS_SECT with STATE=un-handled, go to b).

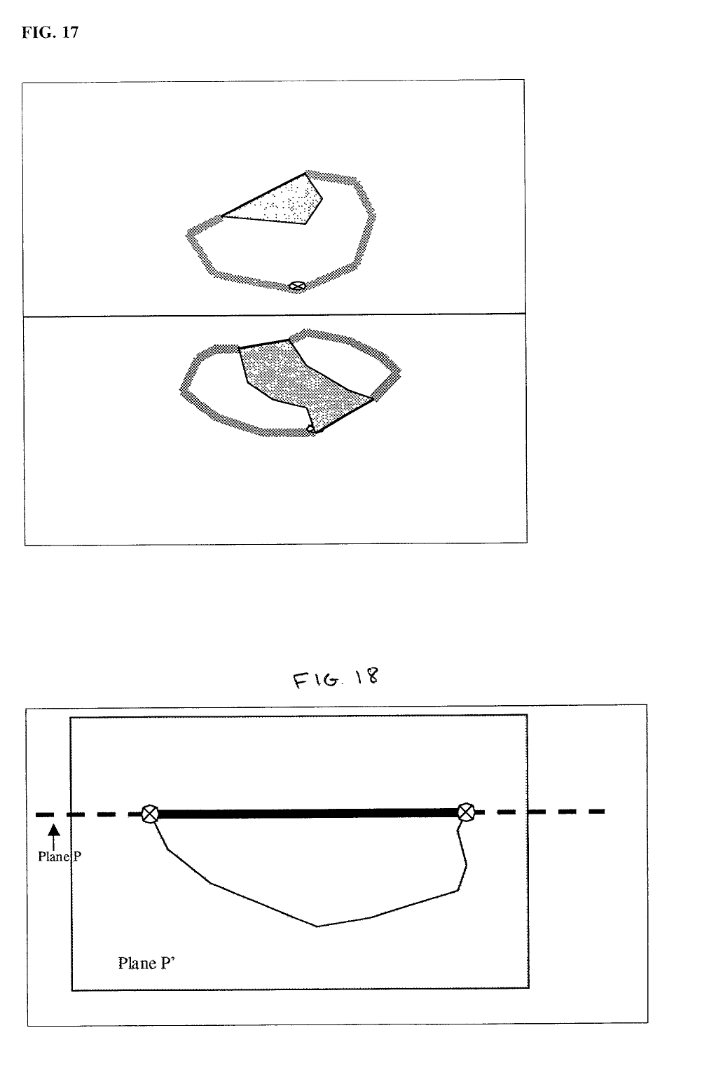

2) Extract all partial openings from the edges in the outer boundary of CROSS_SECT identified in step 1 (See FIG. 17 showing shaded partial openings). A partial opening is a closed polygon which consists of at least one special edge from SPECIAL_EDGES and a set of the edges in CROSS_SECT which were not traversed in step 1(c). Let PARTIAL_OPENINGS be the set of partial openings that are contained in the outer boundary from step 1.

3) For each partial opening PO in the set PARTIAL_OPENINGS:

a) If the area of PO is less than FILTER.MAX_AREA and greater than FILTER.MIN_AREA, and the total length of all special edges in PO is less than FILTER.TOTAL_PARTIAL_LENGTH, go to step (b), else return to step 3 for any remaining partial openings.

b) Let S*=S.

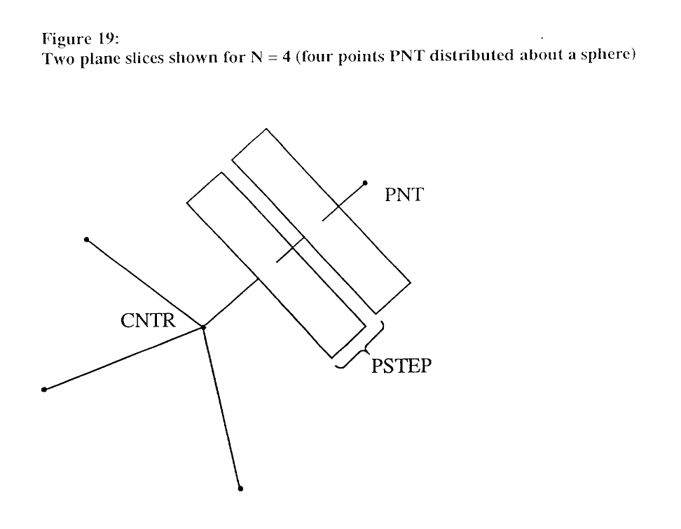

c) For each edge E of PO which is in SPECIAL_EDGES, let P′ be the plane which is contains E and perpendicular to P. Calculate S_{BOTTOM*} using SLICE(S*,P′). Let S′=S_{BOTTOM*} . If the endpoints of E are not plane-connected (with reference to P′) in S′, return to step 3 for any remaining partial openings. (See FIG. 18)

d) Let SIDE be the polygon formed by edge E, and the path of edges on P′ that connect the endpoints of E. If the area of SIDE is less than FILTER.MAX_PARTIAL_AREA, triangulate SIDE, and add the triangles to S′, else go to step 3 until all the remaining partial opening openings have been handled.

e) Let S*=S′, go to step (c) until all remaining special edges in PO have be handled.

4) If the total area of the side polygons added to S* in steps 4-6 is less than FILTER.TOTAL_PARTIAL_AREA, let POCK equal the set of triangles in S* surface connected to PO. If volume of POCK is less than FILTER.MAX_VOLUME and greater than FILTER.MIN_VOLUME, then POCK is a valid partial pocket.

5) Go to 3) until all remaining partial openings in PARTIAL_OPENINGS have been handled.

ALL_POCKETS

ALL_POCKETS(PROT, S,N, P_STEP, FILTER) calculates the protein pockets on surface S of protein PROT subject to the constraints in the filter structure FILTER. Referring to FIG. 19, the protein is sliced by a number of evenly distributed planes spaced apart by P_STEP. As also shown in FIG. 19, N represents a number of orientations of lines through a center of the model, with a series of parallel slices being taken perpendicular to each line out to point PNT. Typical values are: N=514; and P_STEP=1 Angstrom. The protein can be, for example, 10-100 Angstroms along the various orientations. For the exemplary vales of N and P_STEP given above, the method thus determines pockets for about 5,000-50,000 slices.

1) Let CNTR be the location of the center of mass of protein P.

2) Calculate N evenly distributed points on the unit sphere centered about CNTR.

3) For each point PNT calculated in step 2:

a) Let ITER=0

b) let P be the plane whose normal vector is the vector from CNTR to PNT and which contains CNTR+PNT*(ITER+0.5)*P_STEP

c) calculate POCKETS (S, P, FILTER) and add the results to the set COMPLETE_SET.

d) If the intersection of P and S is empty, go to step 3.

e) Let ITER=ITER+1.

f) Go to step a).

4) Return COMPLETE_SET

Examples of Typical Values Used

(All numbers are in units of angstroms)

FILTER.MIN_AREA=45

FILTER.MAX_AREA=540

FILTER.MIN_VOLUME=300

FILTER.MAX_VOLUME=2300

FILTER.TUNNEL_STEP=1

FILTER.TUNNEL_FACTOR=3

FILTER.MAX_TUNNEL_BOTTOM=80

FILTER.MAX_PARTIAL_LENGTH=8

FILTER.MAX_PARTIAL AREA=40

FILTER.TOTAL_PARTIAL_LENGTH=20

FILTER.TOTAL_PARTIAL_AREA=80

Overlapping Pockets

POCKET_VOLUME_MERGE

POCKET_VOLUME_MERGE (P, POCKETS) calculates a set of merged pocket volumes defined by a protein P and its associated set of calculated pockets POCKETS. Given a set of all protein pockets for a given protein, defined by ALL_POCKETS, merged pocket volumes can be defined using POCKET_VOLUME_MERGE. These merged pocket volumes represent the aggregate volume made available by the protein for small molecule binding.

Steps of POCKET_VOLUME_MERGE:

1) Using an arbitrary coordinate system, define a lattice L with cube side length of LATTICE_LENGTH.

2) For each pocket POCK in the set POCKETS, define a set of spheres as follows:

a) Each sphere must be centered on a lattice point in L and have radius BALL_RADIUS.

b) Each sphere center must be contained in the volume defined by the surface triangles and bounding planes of POCK, and must be at least BALL_BUFFER distance away from the protein surface.

c) A sphere will be removed from the set if it does not have at least BALL_CLUSTER_SIZE_CUTOFF neighbors in the set, where each sphere had neighbors consisting of the 26 spheres centered on lattice points in L at most 1 unit from the center of the given sphere in any direction.

3) Define S to be the union of all sets of spheres calculated in the previous step.

4) Check all lattice points within LATTICE_SEARCH distance of the center of any sphere in S, if a sphere of radius BALL_RADIUS around such a point is outside of the volume of the protein, add this new sphere to S.

5) Partition S into connected components, where, as above, each sphere is connected to at most 26 neighboring spheres.

6) The volume occupied by the spheres in each connected component of S is a merged pocket volume.

Examples of Typical Values:

LATTICE_LENGTH=1.65 Angstroms

BALL_RADIUS=1.5 Angstroms

BALL_BUFFER=1.0 Angstroms

BALL_CLUSTER_SIZE_CUTOFF=3

LATTICE_SEARCH=1.0 Angstroms

POCKET_VOLUME_PARTITION

POCKET_VOLUME_PARTITION (P, MP) calculates partitioned pocket volumes, which are subsets of a merged pocket volume MP of a protein P that are suitable for small-molecule binding. Sets of partitioned pocket volumes can be derived from each merged pocket volume using the POCKET_VOLUME_PARTITION algorithm. Each partitioned pocket volume represents a space than could be completely occupied by a small molecule binding to the protein. The partitioned pocket volumes are used to measure binding affinity of a small molecule to the pocket. This can be done, for example, by define quantized cubic representations of the partitioned pocket volume and comparing these to quantized cubic representations of the small molecule.

Steps of POCKET_VOLUME_MERGE:

1) Divide the spheres in MP into a set of surface spheres SS and a set of interior spheres IS as follows:

a) If the closest atom of P has a van der Waals radius within MAX_DISTANCE_TO_VDW of the sphere, it is a surface sphere.

b) Otherwise, it is an interior sphere.

2) Partition SS as follows:

a) Sort the spheres in SS by the number of neighbors each sphere has in the set MP, from spheres with least number of neighbors to spheres with the greatest number of neighbors.

b) Loop through the spheres in order; if a sphere has not been assigned to a partition, create a new partition containing the sphere and its neighbors in SS. Add the partition to the partition list.

c) Sort the partition list from the partition with the least number of spheres to the partition with the greatest number of spheres.

d) Loop through the partitions in order. If a partition PART has fewer spheres than MIN_PARTITION_SIZE, attempt to locate adjacent partitions. That is, partitions containing a sphere that a neighbor to a sphere in PART. If adjacent partitions exist, merge PART with its smallest adjacent partition.

3) Partition IS using the same algorithm used to partition SS.

4) Construct the set SSUNION, containing all possible sets of unions of partitions of SS such that:

a) Each union contains a connected set of spheres.

b) Each union contains at least MIN_SURFACE_UNION_SIZE spheres and at most MAX_SURFACE_UNION_SIZE spheres.

5) Construct all possible unions of individual members of SSUNION (unions of partitions of SS) and zero, one or more partitions of IS such that:

a) Each union contains a connected set of spheres.

b) Each union contains at least MIN_INTERIOR_UNION_SIZE spheres and at most MAX_INTERIOR_UNION_SIZE spheres.

c) The ratio of spheres from IS in the union to spheres from SS in the union is less than MAX_FRACTION_INTERIOR.

d) The spheres from SS contained in the union form one of the unions in SSUNION.

6) Each of the unions constructed in the previous step is a partitioned pocket volume.

Examples of Typical Values:

MAX_DISTANCE_TO_VDW=0.5 Angstroms

MIN_PARTITION_SIZE=8

MIN_SURFACE_UNION_SIZE=10

MAX_SURFACE_UNION_SIZE=50

MIN_INTERIOR_UNION_SIZE=10

MAX_INTERIOR_UNION_SIZE=50

MAX_FRACTION_INTERIOR=0.5

Process Following Determination of Pockets

When all the pockets are determined, they can be sorted and evaluated based on the particular need and on based on desired input parameters. The pocket volume and pocket opening are of particular interest; the user of the method can weight the evaluation in favor of opening area, encompassed volume, or some combination of that area and volume. The weighting of parameters can depend on the purpose of the method. For example, for a desired protein-protein binding site, a larger pocket opening area may be more desirable; for a small molecule site, one may want a large encompassed volume to pocket opening area ratio; or the user may want to weight primarily to the encompassed volume.

It is often desirable to have a simple pocket, or pockets that are nearly simple pockets (pockets with little added area from bounding planes other than the slicing plane). By controlling MAX_TUNNEL_BOTTOM, MAX_PARTIAL_LENGTH, and TOTAL_PARTIAL_LENGTH, a user can favor pockets that are simple pockets or nearly simple pockets. These parameters limit how much an additional plane can be used to define a pocket. In the reduced case where the maximum values identified above are zero, only simple pockets can be found.

The present invention can thus be used to determine concave regions in a 3D structure by evaluating encompassed volumes and pocket opening areas created by cross sectional slices in any modeled irregular 3D structure, including in 3D structures with surfaces having significant convex and concave variations, such as a protein model. More generally, the system and method of the present invention could be used to evaluate surface variations in other structures, e.g., with biomolecules generally, with biopolymers generally, and specifically with proteins.

Software and Hardware Implementation

The system and method of the present invention can be implemented in software or in a combination of hardware and software operating on and executed by a computer, workstation, server, or some other device with one or more CPUs or other processors, or on a device with application specific integrated circuits for processing. The method described here can be successfully implemented, for example, on a 600 MHz, conventional personal computer in several hours for a protein model, and could be performed more quickly on more powerful processing equipment.

The software portions of the present invention can be stored in any desired storage medium, including magnetic media and optical media. Such media typically have a substrate with program data encoded on the substrate, such that when used with an appropriate reader, a computer or computing system can read and execute the encoded program data.

Use of Protein Pocket Evaluation

By defining which areas of a protein surface are most likely sites for ligands to bind, subsequent rational drug design can follow directly from the use of the method described herein. For instance, the specific area of the protein surface can be used as a target surface into which molecules can be measured for potential binding affinity by using any of the following known docking methods: Flexx, AutoDock, Dock, or Gold.

Alternatively, the specific area of the protein surface can be used as a target surface into which molecules can be measured for potential binding affinity by using a method in which (1) protein surfaces and potential ligands are each quantized into cubic formats, and (2) potential binding affinity of ligands is ranked based on complementarity of cubic quantizations of molecules to cubic quantizations of surfaces. Details of such a method are exemplified in Wintner and Moallemi: “Quantized Surface Complementarity Diversity (QSCD): A Model Based on Small Molecule-Target Complementarity,” Journal of Medicinal Chemistry. 2000, vol. 43, pp. 1993-2006, which is incorporated by reference herein.

QSCD, in addition to mapping and comparing existing compounds, is also a “reversible model.” This means that it allows for unfilled points in diversity space to be filled by direct modeling of molecular libraries into detailed 3D templates. Using a set of known test compounds, the model is shown to be biologically relevant, consistently scoring known actives as similar; i.e., comparisons of compounds known to be similar and dissimilar have scored high and low, respectively, for diversity. The model has further been validated by its ability to predict the general shape and functionality of protein surfaces to which known ligands bind. Finally, the model presents an opportunity to characterize known protein motifs by 3D shape and functional similarity.

QSCD takes a molecular structure and creates conformations. These conformations are quantized, essentially by using small blocks to represent each conformation. These quantized conformations are compared and scored against all theoretical target surfaces.

Using a pocket volume and opening area and comparing to quantized ligands, one can determine ligands likely to bind at the pocket.

After potential binding affinity of ligands is ranked using one of the methods listed above, the ligands thus ranked can be synthesized and tested in a binding assay for actual binding affinity to the protein of interest. An exemplary screening method is described in published patent application W099/35109, which is incorporated herein by reference.

### EXAMPLES

The method described above was used in a proof of principle study with four protein crystal structures that have known ligands: HIV-1 Protease, Heat Shock Protein-90, Stromelysin, and Dihydrofolate Reductase. For each protein, the 3D atomic surface of the protein was calculated and then sliced with planes using the methodology of the present invention to define potential ligand pockets. Parameters used for a filter are those typical parameters listed above as typical values used. All potential ligand pockets were sorted according to encompassed pocket volume.

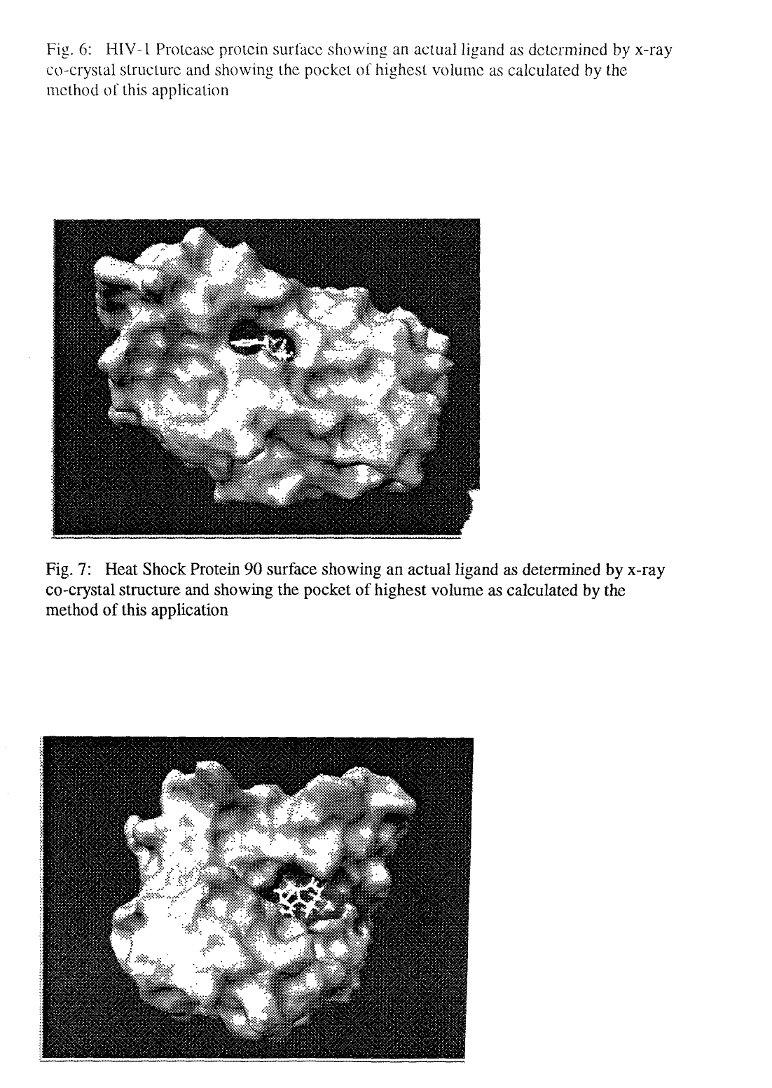

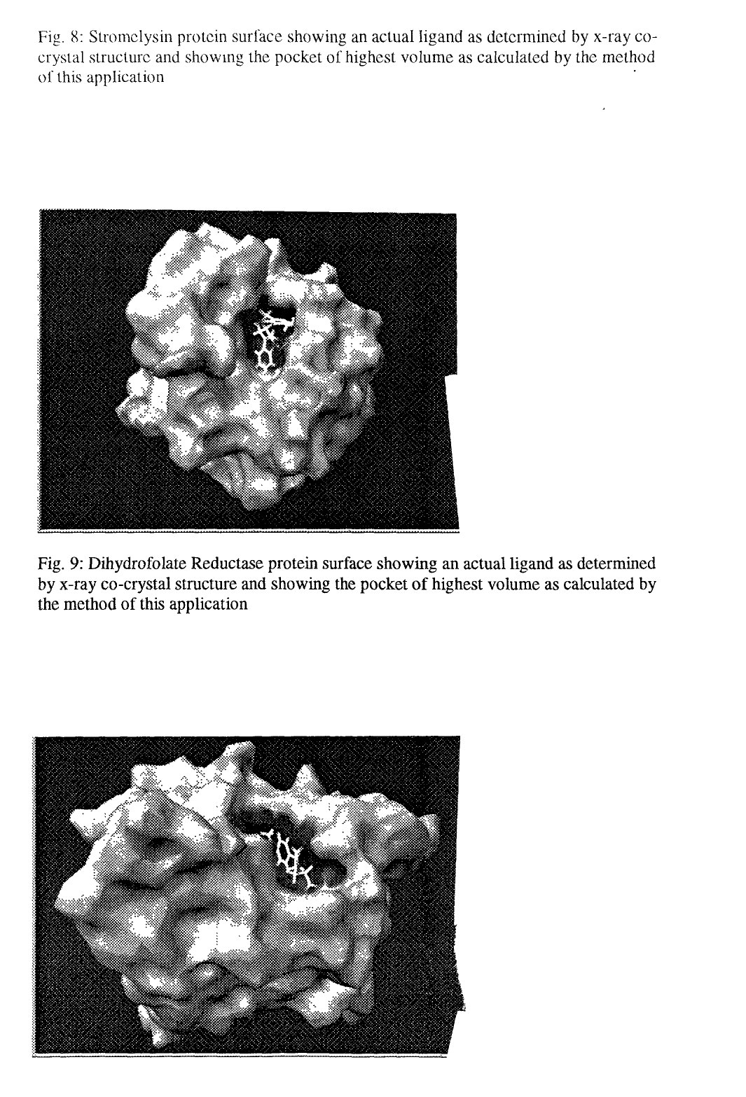

Actual ligand pockets were determined by x-ray structure (FIGS. 6-9). In all four cases, the pocket of highest volume as calculated by the method of the present invention matched the actual ligand pockets in actual practice, as shown in FIGS. 6-9, which represent HIV-1 Protease, Heat Shock Protein-90, Stromelysin, and Dihydrofolate Reductas, respectively. In these figures, FIG. 6 is a tunnel pocket, and FIGS. 7-9 are partial pockets.

These experiments thus show the method of the present invention is useful as a computational tool to assess the ligand binding potential of multiple areas of a protein surface.

Modifications can be made and further features added or provided without departing from the scope of the appended claims.

What is claimed is:

1. A computer-implemented method comprising determining concave areas on an irregular computer model surface by intersecting the surface with a number of planar slices, determining, for at least two slices, parameters based on the intersection between the surface and the slice, and using the at least two determinations to determine a preferred concave region of the surface.

2. The method of claim 1, further including, for at least one slice, determining a closed volume bounded by only the surface and the slice.

3. The method of claim 1, further including, for at least one slice, determining a closed volume bounded by the surface, a slice, and one or more planes that are perpendicular to the slice.

4. The method of claim 1, further including, for at least one slice, determining a closed volume bounded by the surface, a slice, and a plane parallel to the slice.

5. The method of claim 1, further including, for a first slice, determining a closed volume bounded by only the surface and the first slice; for a second slice, determining a closed volume bounded by the surface, the second slice, and one or more planes that are perpendicular to the second slice; and for a third slice, determining a closed volume bounded by the surface, the third slice, and a plane parallel to the third slice.

6. The method of claim 1, wherein the surface is the calculated surface of a DNA molecule.

7. The method of claim 1, wherein the surface is the calculated surface of an RNA molecule.

8. The method of claim 1, wherein the concave areas on the surface are ranked according to the volume encompassed by the surface and the slice.

9. The method of claim 1, wherein the concave areas on a given surface are ranked according to the pocket opening area created by the intersections of the surface and the slice.

10. The method of claim 1, wherein the concave areas on a given surface are ranked according to a function of both the volume encompassed by the surface and the slice, and the pocket opening area created by the intersections of the surface and the slice.

11. The method of claim 1, wherein the surface is the calculated surface of a protein.

12. The method of claim 11, further including, for a first slice, determining a closed volume bounded by only the surface and the slice; for a second slice, determining a closed volume bounded by the surface, the slice, and one or more planes that are perpendicular to the slicing plane; and for a third slice, determining a closed volume bounded by the surface, the slice, and a plane parallel to the slice.

13. The method of claim 11, further comprising using a portion of the surface intersected by the slice and measuring binding affinity at the portion of the surface.

14. The method of claim 11, further comprising determining protein pockets including pockets bonded only by the surface and the slice pockets bonded by the surface and the slice, and a plane parallel to the slice, and pockets bonded by the surface, the slice, and one or more planes perpendicular to the slice.

15. The method of claim 14, further comprising ranking the pockets according to area of the slice bonded by the surface and any perpendicular planes and/or the volume enclosed by the surface, the slice, and the additional perpendicular or parallel planes.

16. The method of claim 14, further comprising determining, for at least some of the pockets which overlap, the aggregate volume and surface area thus made available for binding by small molecules.

17. The method of claim 14, further comprising, for at least some of the pockets, partitioning the pockets or an aggregate of at least some of the pockets into separate volumes and surface areas that can be occupied by a small molecule binding to the protein.

18. A computer-implemented method comprising:
intersecting a computer model of a protein surface with a series of slices; and
determining for a number of the slices concave areas of the protein surface that are more or less likely for a ligand molecule to bind to the protein.

19. The method of claim 18, further comprising using a specific determined concave area to determine binding affinity for a ligand.

20. The method of claim 19, wherein determining binding affinity includes quantizing the concave area and potential ligands and ranking complementarity there between.

21. A method comprising:
determining concave areas on a surface of a three dimensional computer model of a biomolecule by intersecting the surface with a number of planar slices;
determining, for at least two slices, parameters based on the intersection of the surface and the slices; and
using the determinations to determine a preferred ligand affinity region of the surface.

22. The method of claim 21, wherein the size and shape of the ligand affinity region are used to design a ligand tailored to that affinity region.

23. The method of claim 21, further comprising using a docking method to measure a potential binding affinity to a desired affinity region.

24. The method of claim 21, wherein a volume encompassed by the slice and the surface are determined for each slice.

25. The method of claim 21, wherein the area of intersection between the slice and the surface is determined for each slice.

26. The method of claim 21, further comprising quantizing the ligand affinity region and potential ligands into a cubic format, and ranking potential binding affinity based on complementarity of cubic quantizations of affinity regions to potential ligands.

27. An apparatus comprising a computer-readable storage medium, and program data encoded in the medium for operating on a model of a three dimensional surface, and determining concave areas on the surface of the three dimensional model including intersecting the surface with a number of planar slices, determining for at least two slices a parameter based on the intersection between the surface and the slices, and using the determinations to determine a preferred concave area on the surface.

28. A system comprising a computing system for displaying a three dimensional computer surface and for determining concave areas on the surface including intersecting the surface with a number of planar slices, determining for at least two slices a parameter based on the intersection between the surface and the slices, and using the determinations to determine a preferred concave area of the surface.
